(19) United States
(12) Patent Application Publication
(10) Pub. No.: US 2022/0121941 A1
(43) Pub. Date: Apr. 21, 2022

(54) DRIVING STOCHASTIC AGENTS TO ENGAGE IN TARGETED ACTIONS WITH TIME-SERIES MACHINE LEARNING MODELS UPDATED WITH ACTIVE LEARNING

(71) Applicant: William Goldberg, Winnetka, IL (US)

(72) Inventor: William Goldberg, Winnetka, IL (US)

(21) Appl. No.: 17/505,235

(22) Filed: Oct. 19, 2021

Related U.S. Application Data
(60) Provisional application No. 63/094,180, filed on Oct. 20, 2020.

(51) Int. Cl. G06N 3/08; G06N 3/04

(52) U.S. Cl. CPC G06N 3/08; G06N 3/0472

(57) ABSTRACT

Provided are processes that include: obtaining, with a computer system, a time-series machine learning model trained to influence the actions of an agent; selecting, with the computer system, with the time-series machine learning model, stimuli to drive the agent to engage in a targeted activity; causing, with the computer system, the stimuli to be presented to the agent; obtaining, with the computer system, feedback indicative of whether the agent engaged in the targeted activity; adjusting, with the computer system, parameters of the time-series machine learning based on the feedback; and storing, with the computer system, the adjusted parameters in memory.

### CROSS-REFERENCE TO RELATED APPLICATIONS

This patent claims the benefit of U.S. Provisional Patent Application 63/094,180, filed 20 Oct. 2020, titled FACILITATING HEALTH MANAGEMENT AND SUPPORT WITH MACHINE LEARNING. The entire content of each afore-mentioned patent filing is hereby incorporated by reference.

### BACKGROUND

### 1. Field

The present disclosure relates generally to distributed computing applications and, more specifically, to distributed computing applications that facilitate health management, improved care plan adherence and effectiveness of patient/care provider interaction and related support with machine learning.

### 2. Description of the Related Art

Machine learning techniques are increasingly used to model the behavior of complex agents, like humans. For example, for marketing purposes, machine-learning algorithms are often trained on historical data in which marketing efforts are labeled according to whether they resulted in a sale. In another example, content recommendation systems often include machine learning models trained on historical data indicating which content users consumed. The algorithm's parameters are typically adjusted during training to best-fit the training data, and the trained model is often able to generalize out of sample and make useful predictions responsive to new inputs.

Many existing approaches to modeling humans are not suitable for more complex use cases, e.g., those involving higher-dimensional stochastic optimal control problems. Machine-learning techniques used in marketing and content recommendation often seek to drive a single action by a human agent, e.g., buying from a merchant, or consuming another unit or content. These systems often struggle when seeking to select the appropriate outputs that will motivate members of a heterogenous population to engage in relatively personalized targeted behaviors, especially when the desired output is the initiation and maintenance of personal behavior change that is beyond that which individuals can sustainably achieve on their own. For example, in the field of healthcare, different members of a population will likely need to engage in a wide range of different types of repeated static or changed behavior to improve or maintain their health, depending on their current and prospectively changing medical, socioeconomic, and psychometric state. Layered on this complexity are further challenges, e.g., people's current health behaviors and barriers to change can be rooted in long-standing personal attitudes, choices and habitual activities. Moreover, target behavior can evolve over time as the person's health and mental state changes responsive to model outputs, changes in personal awareness, engagement and new skill mastery as well as environmental factors, including aging, life circumstances and social support. Machine learning techniques optimized for the narrower user-cases of marketing or content recommendation are generally not suitable for this richer, more complex class of problems. In the particular case of health management, conventional machine learning must be paired with data analytics-informed multi-element feedback loops to facilitate recursive care plan refinement at a level of daily engagement and progress, speed and scale that is much greater than that which individual and/or their health care provider(s) can accomplish on their own.

### SUMMARY

The following is a non-exhaustive listing of some aspects of the present techniques. These and other aspects are described in the following disclosure.

Some aspects include processes that include: obtaining, with a computer system, a time-series machine learning model trained to influence the actions of an agent; selecting, with the computer system, with the time-series machine learning model, stimuli to drive the agent to engage in a targeted activity; causing, with the computer system, the stimuli to be presented to the agent; obtaining, with the computer system, feedback indicative of whether the agent engaged in the targeted activity; adjusting, with the computer system, parameters of the time-series machine learning based on the feedback; and storing, with the computer system, the adjusted parameters in memory

Some aspects include distributed computing applications that facilitate health management (e.g., engagement, education, implementation and skills mastery, and related support) with machine learning.

Some aspects include a tangible, non-transitory, machine-readable medium storing instructions that when executed by a data processing apparatus cause the data processing apparatus to perform operations including the above-mentioned application.

Some aspects include a system, including: one or more processors; and memory storing instructions that when executed by the processors cause the processors to effectuate operations of the above-mentioned application.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of a computing environment in which the present techniques may be implemented; and

FIG. 2 illustrates an example of a computing device in the environment of FIG. 1.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of machine learning, health care, data exchange, analytics, iterative bi-directional skills training and results reporting and stochastic optimal control. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Cancer care is a very rapidly changing, complex, and data-intensive field to which the some or all of the presently described innovations in predictive analytics, machine-learning powered personalization, and data-driven multi-element feedback loop and recursive skills training and care plan refinement can be applied, among other use cases.

Current circumstances demand it: rapidly proliferating scientific knowledge (an estimated 2.5 million new articles published in 30,000 journals annually); expanding cancer diagnoses (1.9 million per year in the US); and a rapidly growing population of cancer survivors (18 million in the US alone) overwhelm the roughly 13,000 active oncologists in the US. Some of the technological innovations detailed in this patent application can be harnessed to extend patient access and physician reach (while reducing administrative burden) and to reduce physician and site of care-level variability, which in some use cases are expected to collectively a) improve health outcomes and b) patient experience, c) decrease cost of care and d) reduce rising clinician burnout and dropout.

Cancer care typically starts with diagnosis and technology-assisted earlier diagnosis increases treatment options and near-term survival rates. Some embodiments implement machine learning and predictive analytics technologies configured to find hidden patterns in patients' medical and family histories, symptoms, diagnoses and ongoing treatment records that unveil health risks and identify previously undiagnosed cancer. Other embodiments implement advanced data exchange technologies that facilitate the sharing of AI-curated most current scientific journal articles and decision support tools, together with laboratory test results, pathology results and digital imaging for rapid, fully informed expert second opinion and multi-person global peer review of initial diagnoses. Incorporated patient preference-driven multi-channel messaging may also be used to expand the uptake of conventional Medicare-encouraged cancer screenings. Collectively, some embodiments are expected to be beneficial to the practical deployment of recently developed multi-cancer early detection “liquid biopsy” tests. Some embodiments may assist with earlier and more accurate detection, typing and staging of specific cancers and the codification and execution of cancer care plans, which may incorporate patients' personal values, objectives, and preferences helpful to shared decision making and coordinated “whole person care”.

Following one's cancer diagnosis, selection of tailored therapy may occur—and some embodiments may assist with this meticulous decision by leveraging some of the distributed computing and machine learning detailed in this patent application, which in some use cases, are expected to greatly increase clinicians' shared knowledge, consistent precision and speed (and, therefore, patient access). Here again, in some use cases, precision analytics and AI paired with data-sharing technology-enabled access to authoritative national and international experts, may be applied to individually tailor multi-element combination treatments, matched to an individual patient's particular form and stage of cancer—and increasingly—to the particular genetic mutation that drives the growth and immune system-evasion of each cancer.

Likewise, in some embodiments, following treatment selection, some embodiments may be utilized to improve the management of cancer patients as they go through their care plan. Advanced analytics and machine learning applied to patient data gathered through personalized surveys and bi-directional communications may be harnessed by some embodiments to more closely monitor individuals' symptoms, drug tolerance and side effects at scale. These bi-directional communications may, in some embodiments, be supplemented by data-driven live health coaches or counselors supplemented by AI solutions that serve as digital care team assistants to engage patients in dynamic, relationship-building, personalized and branching (e.g., step-wise and expanding) conversations that accelerate and maintain real time insight and feedback gathering (from patient reported information and connected health data monitoring devices) and skills training in desired health behaviors. This analytics-informed multi-element feedback loop is expected to, in some use cases, more quickly trigger recursive adjustment to care plans. Some embodiments may also be applied to better coordinate the activities and logistics of large clinical teams, providers of supporting medical services, and family caregivers at scale. Some embodiments may further monitor and quickly adjust care plan processes based on “real world data” and “patient reported outcomes” that can multiply the capacity and speed of individual clinicians, thereby potentially delivering improved health outcomes at scale.

Finally, when patients conclude active treatment, some embodiments may be deployed to make the ongoing medical care of “cancer survivors” more efficacious. Some embodiments may smooth patients' transition back to enhanced primary care supported by cancer-specific personalized exercise, nutrition, stress and anxiety reduction, community and educational support. Application of iterative bi-directional engagement, skills training, personalized incentives to motivate improved care plan adherence (including through highly tailored health insurance benefit design) and results reporting and personalized communications combined with machine learning-driven modeling of targeted engagement and health behaviors is expected to reveal patient-level triggers and live and digital health coaching and counseling tools that improve post-cancer care plan compliance while also addressing patients' co-morbid physical and emotional health issues, which may be subject to heightened surveillance due the cancer diagnosis. Similarly, ongoing analysis of patient test and other data collected through digital symptom reporting and sensors, wearables and other patient monitoring devices may be used by some embodiments to identify recurring illness early to maximize options. When cancer does reoccur, highly personalized data-directed live and health coaching may be implemented with some embodiments to support the patient and care team through the renewed process of treatment selection, care coordination and, if necessary, highly personalized and family-based advance care planning considerations.

This cancer-specific example demonstrates the collective power and personal and societal impact of some of the technological innovations detailed in this patent application. That said, it should be emphasized that embodiments are not limited to systems that afford all of these advantages or to cancer-related use cases, which is not to suggest that any other description herein is limiting.

Some embodiments select stimuli to drive an agent to engage in a targeted activity expected to increase the likelihood of a desired outcome. Some embodiments do so with active learning, in some cases with unsupervised portions of a machine learning pipeline. In some cases, the space of candidate stimuli and targeted activities are relatively high dimensional (e.g., with more than 4, more than 10, or more than 50 dimensions, respectively), with different agents needing to engage in different types of acts at different times and based on different conditions to increase the likelihood of the desired outcome given their respective state. In some cases, control is exercised in discrete time or continuous time, and in some cases, both the agent's response to a stimulus and the response of the systems under control may have a stochastic component. Some embodiments are implemented with various forms of time-series machine learning models, like reinforcement learning (e.g., deep reinforcement learning models trained with stochastic gradient descent, in some cases, with off-policy learning) or dynamic Bayesian networks (e.g., with hidden Markov models trained with the Baum-Welch algorithm).

These techniques have wide applicability in both directing the behavior of human agents and in directing the behavior of non-human agents, like robots and industrial processes in order to initiate, reward and sustain targeted behaviors and progressive behavior change. That said, the present techniques are described with reference to a particular class of use cases in the field of health care. This should not be read to suggest that the present techniques are limited to that field, which is not to suggest that any other description herein is limiting.

Some embodiments use personally selected rewards and incentives that can be earned quickly and simply and that are aligned to care plan elements, e.g., for elderly or other hard-to-engage populations or other users. Some embodiments select action-based incentives aligned to care plan elements. For example, some embodiments may determine to offer a reward to a user for taking specified health improvement actions, including administration of a medication as prescribed. Or some embodiments may offer rewards triggered by output of a user-worn activity monitor, e.g., offering a reward for prescribed physical activity, nutritional changes or human interaction or social support in furtherance of an individual's proactive health improvement plan. Similarly, rewards may be highly personalized, e.g., a user may indicate that they wish to dance at their granddaughter's wedding in six months, and embodiments may, in response, determine to offer a voucher or discount on a plane ticket to the location of the wedding as a reward for engaging in a targeted action matched to that personalized goal established in the context of a personalized but evidence-based care plan. A wide variety of targeted actions and rewards are contemplated, and both may be customized based on the user's profile, past behavior and response to care plan elements, user and health professional-furnished data and other stimuli. Embodiments are expected to perform with precision at scale, in some cases responsive to measured outcomes, user experience and continuous learning and skill mastery that perpetuate engagement for real health gains.

In some cases, a user profile may be formed responsive to a survey populated by the user at on-boarding. The resulting profile may be used to select rewards and targeted actions by traversing a response-rate driven decision tree that may involve a shared role in care plan decision making when multiple treatment choices and trade-offs exist. As such, embodiments may produce outputs based on personal preferences of users, as indicated in both survey responses and interpersonal interaction with health care team members and others, e.g., indicating how they would like embodiments to engage with them and indicating whether they want their family involved in communications or motivating targeted actions.

In some cases, profiles, rewards, and targeted actions may be adjusted over time responsive to feedback from previous outputs. Examples of such feedback include user responses to updated surveys, user compliance rates, health measures reported by medical devices (like wearable health monitors) and physician supplied measures of health. In some cases, these forms of feedback may be logged (e.g., anonymously) as a time series, and results may be used to implement future training of the model (e.g., to construct a longitudinal data model of the agent or environment used for off-policy learning in a deep reinforcement learning model). In addition to their use in iteratively training the model, these validated patient and health care provider-generated data sets form the backbone of the real-world evidence helpful to government, health system and health insurance entities striving to improve health outcomes, patient access and experience and the overall cost of care.

In some cases, targeted actions may correspond to care plan guidelines and national medical guidelines, which are subject to change due to scientific advancement and other factors. For example, if the care guidelines for a particular type of cancer recommend taking a particular drug and the side effect is lethargy, some embodiments may select a countervailing targeted activity, tied to a reward, e.g., targeting a certain step count or attendance at a patient support group.

Some embodiments are expected to exceed what a human physician could consistently do at scale, due to volume of data ingested related to a particular user or group of users with common characteristics, granularity of rewards and targeted activities among candidate sets of the same, consistency of monitoring, control, analytics and reporting, and differences in the way the described models reach a result relative to mental processes. Further, some embodiments are also expected to exceed the performance of simpler native application-based approaches, where the response rate and persistency of use tends to fall, often due to the inability of the native application's logic to contend with the stochasticity, transience, and complexity of human behavior. Some embodiments may present targeted activities and rewards that are perceived as new and interesting to a given user to sustain engagement over time, critical factors in achieving and sustaining care plan efficacy and individual health in highly dynamic and evolving circumstances upon which numerous internal and external factors act.

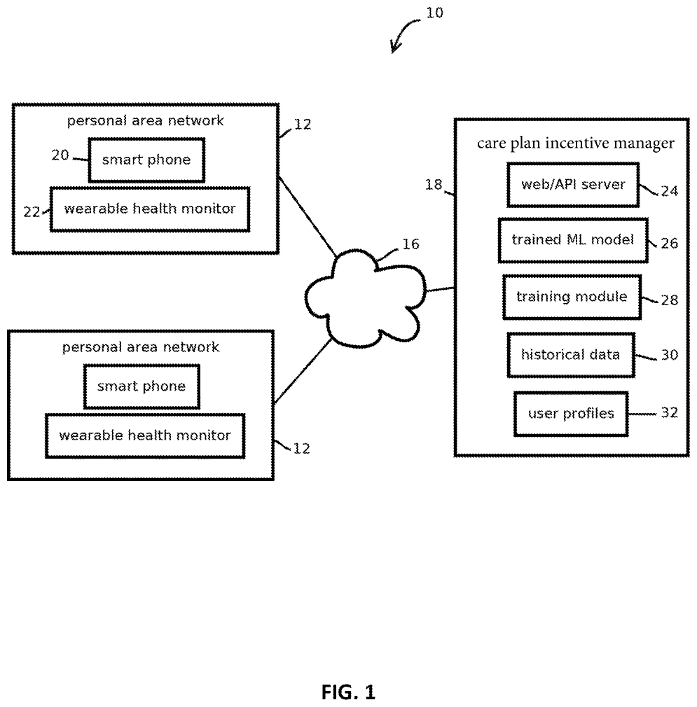

FIG. 1 illustrates an example of a computing environment in which the present techniques may be implemented. Some embodiments may engage with a collection of users, each of which may have one or more computing devices, for instance, connected in respective personal area networks 12, like Bluetooth networks, wired networks, or the like. In some embodiments, those networks may communicate via the Internet 16 with a remote care plan incentive manager application 18, which may be hosted, for example, in a data center. Computing devices of two users are shown, but embodiments are expected to include substantially more, for instance, more than 10,000, more than 100,000, or more than a million total users or concurrently active users engaging with the care plan incentive manager application 18 and the users themselves to promote social support and interaction pivotal to initiating and sustaining health behavior change that is integral to the maintenance, if not improvement, of one's health.

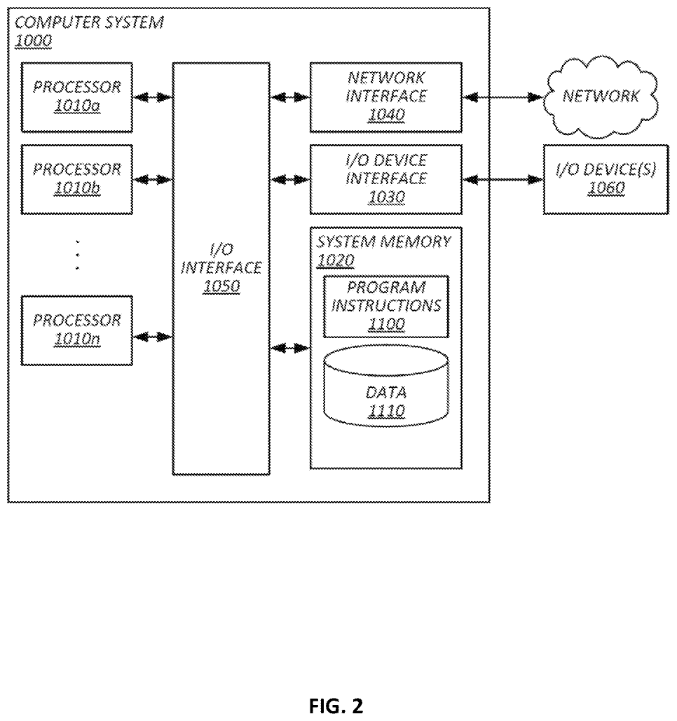

In some embodiments, each user may have a smart phone 20 and a wearable health monitor 22, or collection thereof. Or in some cases, users may interface with the application 18 via other types of computing devices, like smart speakers, set-top boxes connected to the television, laptops, desktops, or kiosks in the user's home, an elder-care facility or other setting such as a retail pharmacy. Each of the illustrated devices may include the components of a computing device described below with reference to FIG. 2. The wearable health monitor 22, or collection of such monitors associated with the user, may include things like a heart-rate monitor, blood-oxygen level monitor, step counter, a sleep monitor, a blood sugar level monitor, and remote electrocardiogram, or the like. In some embodiments, the health monitors may also include sensors in the user's residence, like video cameras configured to detect and calculate aggregate scores of movement, balance or gait or sensors in toilets configured to measure attributes of bodily fluids, refrigerator sensors configured to detect when the refrigerator is accessed and what foods and liquids are consumed, and smart pill bottles configured to detect and report the consumption of pharmaceuticals as prescribed. In some cases, these monitors may communicate via the smart phone 22 through the personal area network 12 or directly to a telephonic or video health coach, digital care team assistant or a remote server, for instance, the care plan incentive manager application 18 or another server system to which the application 18 has access. The smart phone 20 may execute a native application or web browser through which the user interfaces with the care plan incentive manager 18, and in some cases, the smart phone 20 is configured to receive an intervention with a live or digital health coach or push notifications, for instance, with Firebase Messaging Service or Apple Push Notifications on Android or iOS operating systems, respectively. In some cases, the user interfaces and notifications described below may be presented to the user through one of these protocols or processes on the user's smart phone or other computing interface.

In some embodiments, the care plan incentive manager application 18 may be implemented as a monolithic application or as a collection of services, like in a service-oriented architecture, such as a micro services architecture hosted in a data center. In some embodiments, various processes described with reference to the application 18 may be replicated as different instances, for example, in different virtual machines, containers, or lambdas in serverless implementations, in some cases as elastically scalable sets of in such instances behind a load balancer. In some cases, data may be encrypted both in transit and at rest.

In some embodiments, the care plan incentive manager application 18 may include a web or API server 24, a trained machine learning model 26, training module 28, a historical data repository 30, and user profiles 32. In some embodiments, the application 18 may interface with users via the server 24, which may send instructions by which user interfaces are constructed, like web content, notifications, scripts, and other data by which user interfaces are rendered or otherwise presented. Further, server 24 may receive user inputs and effectuate responsive actions that may utilize analytical algorithms trained to sustain and improve response rates over time.

The trained machine learning model 26 may perform the operations described elsewhere herein whereby targeted actions and corresponding rewards are determined. In some embodiments, the trained machine learning model is a composition of a collection of sub-models, like in a pipeline. Some embodiments may implement an ensemble model of the collection of sub-models, like a random forest decision tree that aggregates outputs of a collection of other models. In some embodiments sub-models may include models configured to analyze natural language text and classify the same according to sentiment or into an ontology of recognized features for downstream models. Examples of such natural language processing models currently contemplated include transformer architectures, latent Dirichlet allocation models, and latent semantic analysis models.

In some embodiments, the trained machine learning model includes the above-examples of time series machine learning algorithms and resulting feedback loops. In addition to the types of reinforcement learning and hidden Markov models described above, other examples include long-short term memory models, or other recurrent neural networks, and instances of transformer architectures, for instance with multi-headed attention applied to sequences of targeted actions, rewards, and measures of feedback.

In some embodiments, the training module 28 may train the machine learning model 26, for instance, as a batch process performed off-line (e.g., nightly or monthly or more or less often) or with active online training. In some cases, training involves adjusting parameters of the model, like weights and biases, of which there may be more than 10,000; 100,000; or 1,000,000. In some embodiments, parameters may be adjusted based upon an objective function, like a fitness function or error function. Some embodiments may adjust model parameters with a form of stochastic gradient descent. Some embodiments may compute a partial derivative of model parameters relative to the objective function, for instance, as applied to a training set, and adjust the respective model parameters in a direction that the partial derivative indicates tends to locally optimize the objective function. Such computations may be iteratively repeated until changes in the objective function, as applied to a training set, between interactions that are less than a threshold. Some embodiments may repeatedly repeat this process with different randomly chosen initial conditions to reduce the risk of optimizing to a local optimum.

Some embodiments may store feedback in the historical data repository 30. Examples of feedback include the various outputs of the health monitors described above, user interactions within interface of the application 18, inputs from a physician or other healthcare provider, and medical histories, like medical interventions different from those targeted by the manager 18. In some cases, each such record may be associated with a timestamp or other indication of a sequence and a history of such records and an identifier of a user to which they respond and whose health they reflect, which in some cases may be an anonymized identifier, like a cryptographic hash based upon personally identifiable information and a salt value.

Some embodiments may further include a user profile repository 32, which in some cases may include user responses to surveys like those described herein and user inputs to configure the behavior of the application 18. In some embodiments, these values may be in a structured data format that may be interrogated by the model 26 when determining a next targeted action and reward to output.

In some embodiments, additional computing devices, operated by users with other roles, may interface with the application 18 in the embodiment of FIG. 1. For example, health coaches and other user counselors (e.g., that are not physicians) may be directed to undertake certain actions by the application 18 to effect certain target actions on behalf of a user receiving care. In some cases, other users may be doctors, nurses, or physician's assistants that may input treatment plans that inform selection of targeted actions and direct activities of the health coach assigned to a user receiving care. In some cases, a health coach may log, in the application 18, their actions and observations regarding the user receiving care, in user interaction case notes or other records associated with an identifier of such a user. Other health care professionals, like doctors who often have relatively limited time to spend with patients, may review these logged entries before or during meetings with patients to make their meetings more efficient and effective. Often physicians are allotted relatively little time (e.g., less than 15 minutes) to meet with a patient, and much of that time is spent on tasks other than acquiring new information about the patient. Entries from a heath coach about the patient, logged and provided by application 18, may be presented to the physician in a user interface on the physician's computing device (e.g., in a special purpose native application or web application) to reveal things like, whether the patient has adhered to instructions and taken their medication, reasons and correlates of deviation from such prescriptions or care plan elements, and relevant patterns observed by the health coach over a longer duration of time in a less time-pressured setting and more iterative interpersonal or digital exchange. In some embodiments, the application 18 may implement a published/subscribed messaging pattern. Health coaches may publish entries to a channel associated with a patient identifier, and physicians may subscribe to those channels. In some cases, such entries may be exported to a heath record system, e.g., in a format consistent with the Fast Healthcare Interoperability Resources (FHIR) specification, for presentation in a user interface typically used in the physician's practice. In some embodiments the data gathering, sharing and assessment of the physicians, allied health professionals, coaches, caregivers and patients may be augmented by the use of digital care assistants or bots. Through these means the physician may leverage the work of and data generated by other allied health professionals, which is expected to enable the physician to apply their time with the patient on follow-up or clinically pressing items so that the physician's time is more impactful and value-added.

In some embodiments, entries by heath coaches (and others, like patients, family members, and counselors) may be in unstructured, natural language text, in some cases, being entered via a microphone by spoken audio and transcribed with a speech-to-text module of the application 18. In some embodiments, various natural language processing techniques may be applied to that text to produce structured outputs that expedite physician review, data exchange and analysis. Examples include automatic text summarization, information extraction, named entity recognition, sentiment analysis, and topic modeling. In some cases, the outputs of these forms of natural language processing may be presented to a physician with a different visual weight depending upon the value the output takes, e.g., mentions of chest pain may warrant a red flag in a physician's user interface, and text correlating with depression may be formatted in bold.

Example embodiments are described in the technical product specification in U.S. Provisional Patent Application 63/094,180, the contents of which are hereby incorporated by reference.

FIG. 2 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein on either a synchronous or asynchronous basis. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer systems, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a remote data collection device or performance monitor, a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

1. A tangible, non-transitory, machine-readable medium storing instructions that, when executed by one or more processors, effectuate operations comprising:
obtaining, with a computer system, a time-series machine learning model trained to influence the actions of an agent;
selecting, with the computer system, with the time-series machine learning model, stimuli to drive the agent to engage in a targeted activity;
causing, with the computer system, the stimuli to be presented to the agent;
obtaining, with the computer system, feedback indicative of whether the agent engaged in the targeted activity;
adjusting, with the computer system, parameters of the time-series machine learning based on the feedback; and
storing, with the computer system, the adjusted parameters in memory.

2. The medium of claim 1, wherein:
the agent is a robot;
control is exercised in discrete time; and
the time-series machine learning model comprises a reinforcement learning model having a policy implemented with a multi-layer neural network trained with stochastic gradient descent using, for at least some of the training, off-policy learning.

3. The medium of claim 1, wherein:
the agent is an industrial process;
selecting stimuli comprises steps for selecting stimuli; and
the time-series machine learning model comprises a dynamic Bayesian network trained with the Baum-Welch algorithm.

4. The medium of claim 1, wherein:
the agent is a human agent; and
selecting stimuli comprises steps for care plan refinement.
